(19) United States
(12) Patent Application Publication
(10) Pub. No.: US 2024/0102222 A1
(43) Pub. Date: Mar. 28, 2024

(54) LAUNDRY APPLIANCES LOAD TRACKING AND DELIVERY

(71) Applicant: Haier US Appliance Solutions, Inc., Wilmington (DE)

(72) Inventor: Myunggeon Chung, Louisville, KY (US)

(21) Appl. No.: 17/955,050

(22) Filed: Sep. 28, 2022

(51) Int. Cl. D06F 34/05; D06F 23/02; D06F 33/32; D06F 37/42; D06F 58/02; D06F 58/36; D06F 95/00; G06Q 10/08; G06Q 20/40

(52) U.S. Cl. CPC D06F 34/05; D06F 23/02; D06F 33/32; D06F 37/42; D06F 58/02; D06F 58/36; D06F 95/00; G06Q 10/083; G06Q 20/40; D06F 2101/20

(57) ABSTRACT

A method of operating a laundry appliance includes initiating an operation cycle of the laundry appliance in response to a command from a primary user via a first remote user interface device. The method also includes providing a prompt on the first remote user interface device. The prompt on the first remote user interface device includes a delivery inquiry. The method further includes receiving an affirmative response to the delivery inquiry. The method also includes locating a secondary user and providing a prompt on a second remote user interface device associated with the secondary user after receiving the affirmative response to the delivery inquiry. The prompt on the second remote user interface device includes a delivery request. The method further includes receiving an affirmative response to the delivery request. The method also includes providing a delivery confirmation on the first remote user interface device.

### FIELD OF THE INVENTION

The present subject matter relates generally to systems and methods for tracking a load of articles in a laundry appliance, such as systems and methods for tracking progress of an operation cycle treating the load of articles in the laundry appliance and delivering the treated articles to a user's residence.

### BACKGROUND OF THE INVENTION

Laundry appliances generally include washing machine appliances and dryer appliances. Some laundry appliances are publicly available, such as commercial laundry appliances available for rent, e.g., in a laundromat. Operation cycles of laundry appliances, e.g., wash cycles in a washing machine or drying cycles in a dryer appliance, can take a significant amount of time. For this reason, many users choose not to wait while the laundry appliance is running. Instead, such users may run errands or otherwise leave the laundry appliance unattended during operation.

Users who choose not to wait while the laundry appliance is running may be unable to return and retrieve their articles from the laundry appliance when the operation cycle(s) is or are complete. Thus, the articles may remain unattended in the laundry appliance for an extended period of time, which may result in loss of profit for the laundry appliance owner, e.g., because other users are unable to rent the laundry appliance while the absent user's articles remain therein, and may result in detrimental effects to the load of articles, such as when the load of articles is damp and remains enclosed within the laundry appliance for the extended period of time.

Thus, systems and methods for tracking progress of a laundry cycle and notifying a user thereof would be beneficial. Further, systems and methods for locating another user to deliver the load of articles would be beneficial.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of operating a laundry appliance is provided. The method includes initiating an operation cycle of the laundry appliance in response to a command from a primary user via a first remote user interface device. The method also includes determining the operation cycle is within a completion threshold and the first remote user interface device is more than a predetermined threshold distance away from the laundry appliance. The method further includes providing a prompt on the first remote user interface device because the operation cycle is within the completion threshold and the first remote user interface device is more than the predetermined threshold distance away from the laundry appliance. The prompt on the first remote user interface device includes a delivery inquiry. The method also includes receiving an affirmative response to the delivery inquiry. The method further includes locating a secondary user and providing a prompt on a second remote user interface device associated with the secondary user after receiving the affirmative response to the delivery inquiry. The prompt on the second remote user interface device includes a delivery request. The method further includes providing a delivery confirmation on the first remote user interface device.

In accordance with another embodiment of the present disclosure, a method of operating a laundry appliance is provided. The method includes initiating an operation cycle of the laundry appliance in response to a command from a primary user via a first remote user interface device. The method also includes providing a prompt on the first remote user interface device. The prompt on the first remote user interface device includes a delivery inquiry. The method further includes receiving an affirmative response to the delivery inquiry. The method also includes locating a secondary user and providing a prompt on a second remote user interface device associated with the secondary user after receiving the affirmative response to the delivery inquiry. The prompt on the second remote user interface device includes a delivery request. The method further includes receiving an affirmative response to the delivery request. The method also includes providing a delivery confirmation on the first remote user interface device.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary washing machine appliance and an exemplary dryer appliance in accordance with one or more exemplary embodiments of the present disclosure.

FIG. 2 provides a transverse cross-sectional view of the exemplary washing machine appliance of FIG. 1.

FIG. 3 provides a perspective view of the exemplary dryer appliance of FIG. 1 with portions of a cabinet of the dryer appliance removed to reveal certain components of the dryer appliance.

FIG. 4 provides a schematic diagram of a laundry appliance in communication with a remote user interface device and a remote computing device according to one or more embodiments of the present disclosure.

FIG. 5 provides a flowchart illustrating an example method of operating a group of laundry appliances according to one or more embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

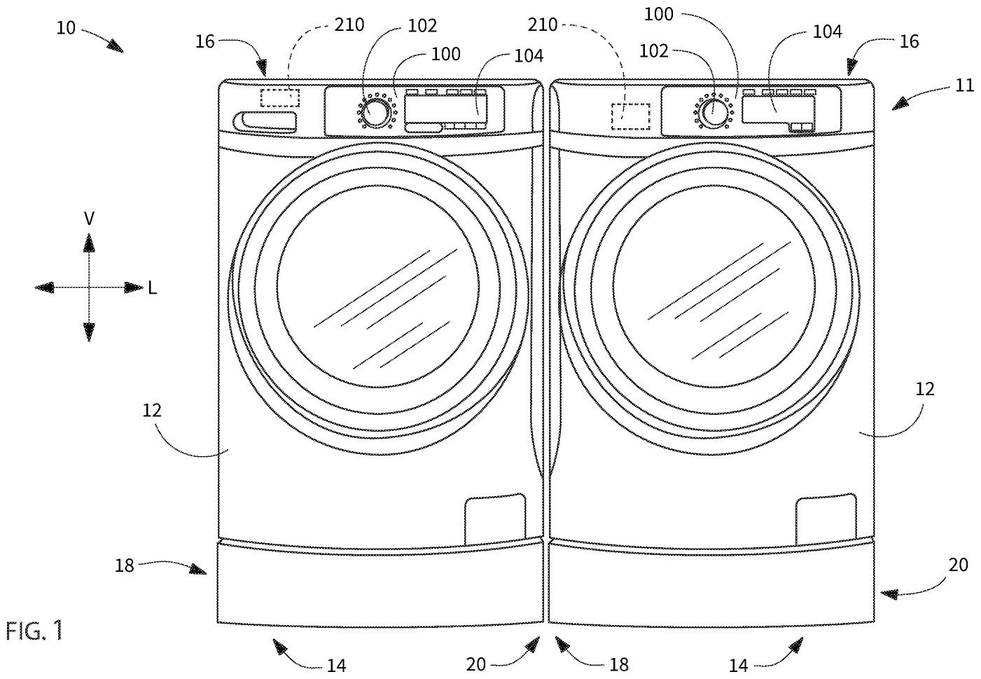

Exemplary laundry appliances are illustrated in FIGS. 1 through 3, e.g., a washing machine appliance and a dryer appliance. In various embodiments of the present subject matter, a laundry appliance may be any suitable laundry appliance, such as a washing machine appliance, a dryer appliance, a combination washer-dryer appliance, etc.

As may be seen generally throughout FIGS. 1 through 3, a user interface panel 100 and a user input device 102 may be positioned on an exterior of the laundry appliance. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, each appliance may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance. Operation of the appliance can be regulated by the controller 210 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance. Controller 210 may include a memory and one or more microprocessors, CPUs or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, a laundry appliance may be a washing machine appliance 10 or a dryer appliance 11, and a group of laundry appliances may include multiple washing machine appliances 10 or multiple dryer appliances 11. In embodiments such as illustrated in FIG. 1, the user input device 102 of each appliance 10 and 11 may be positioned on the user interface panel 100. The embodiment illustrated in FIG. 1 also includes a display 104 on the user interface panel 100 of each household appliance 10 and 11.

As generally seen throughout FIGS. 1 through 3, in at least some embodiments, each laundry appliance 10 and 11 includes a cabinet 12 which defines a vertical direction V, a lateral direction L, and a transverse direction T that are mutually perpendicular. Each cabinet 12 extends between a top side 16 and a bottom side 14 along the vertical direction V. Each cabinet 12 also extends between a left side 18 and a right side 20, e.g., along the lateral direction L, and between a front side 22 and a rear side 24 along the transverse direction T.

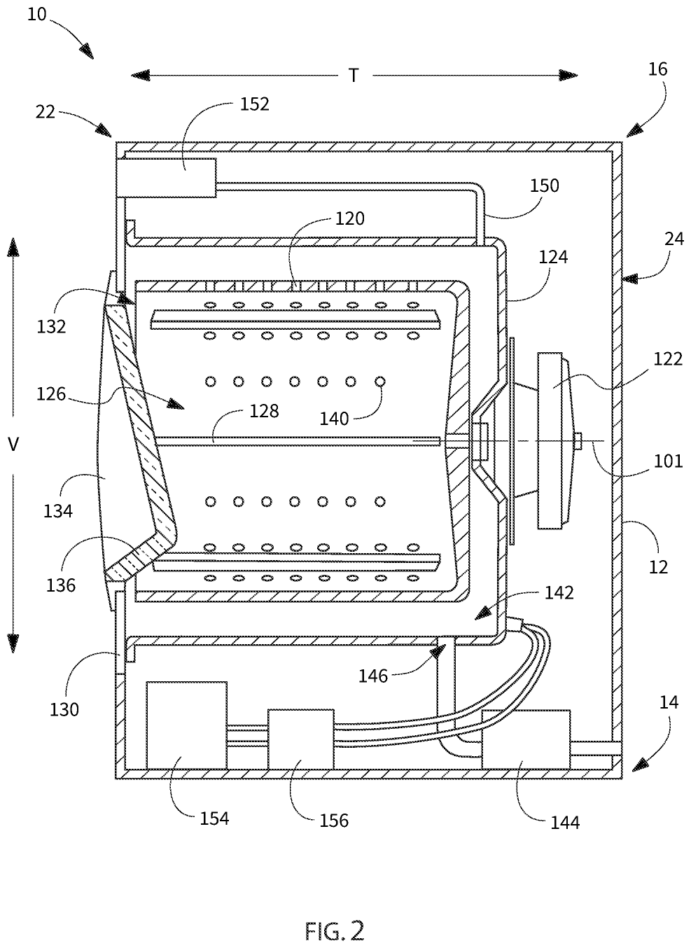

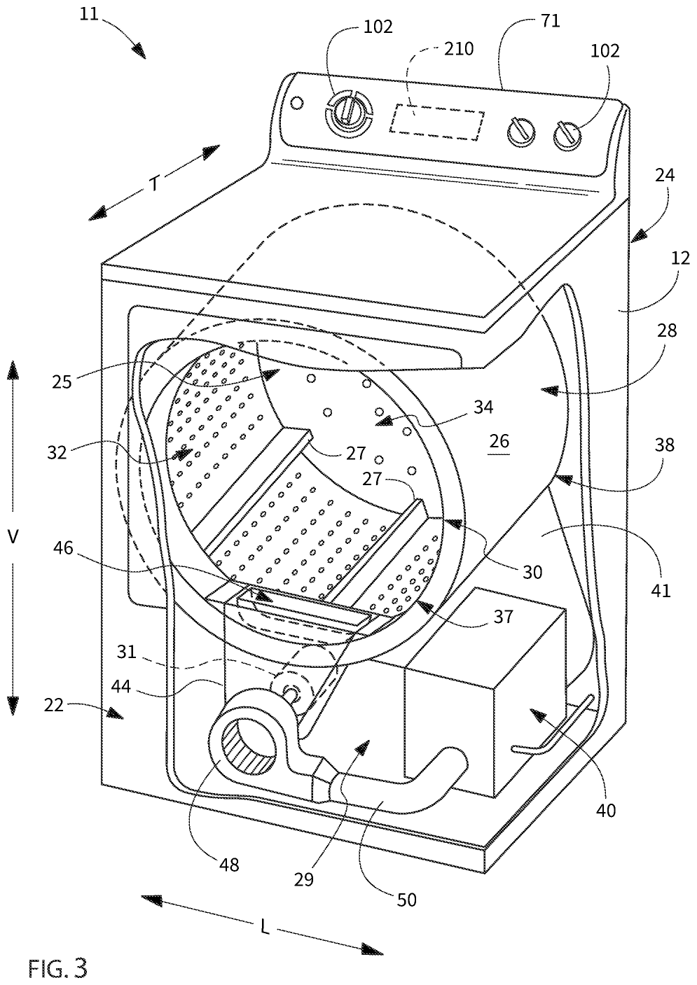

Additional exemplary details of each laundry appliance are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, e.g., during a wash cycle of the washing machine appliance 10, a laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1, which is an example embodiment of a laundry appliance, with a portion of a cabinet or housing 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on the cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 210 may be programmed to operate dryer appliance 11 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 210.

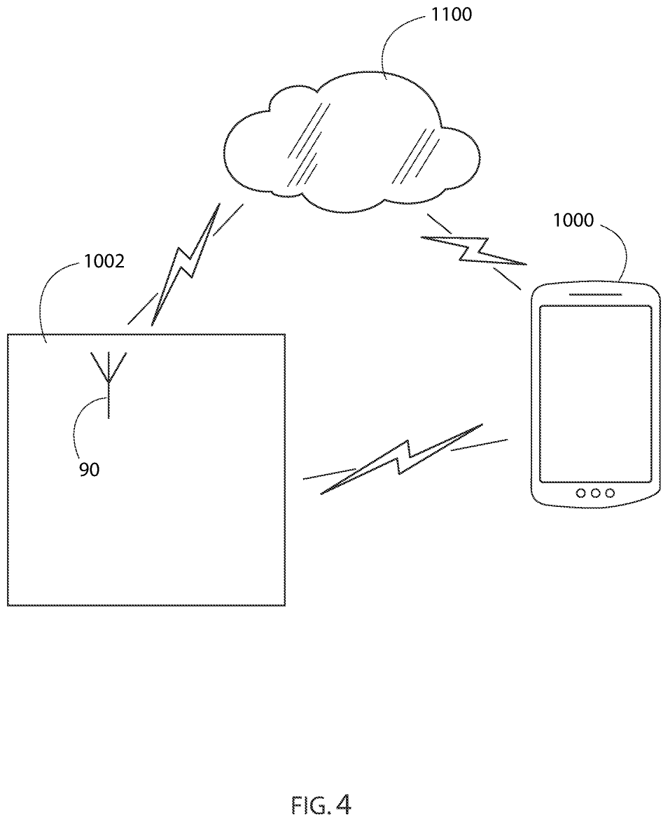

Turning now to FIG. 4, a general schematic of a laundry appliance 1002, which may be, e.g., the washing machine appliance 10 or the dryer appliance 11 described above, and communication features thereof is provided. FIG. 4 schematically illustrates a laundry appliance 1002, which may be, for example, one of the laundry appliances 10 or 11 of FIGS. 1 through 3, among other possible example laundry appliances, which communicates wirelessly with a remote user interface device 1000. For example, as illustrated in FIG. 4, the laundry appliance 1002 may include an antenna 90 by which the laundry appliance 1002 communicates with, e.g., sends and receives signals to and from, the remote user interface device 1000. The laundry appliance 1002 may communicate with the remote user interface device 1000 over a direct wireless communication link or over an indirect wireless communication link, such as via a remote server, a network, or cloud 1100. The remote user interface device 1000 may be a laptop computer, smartphone, tablet, personal computer, wearable device, smart home system, and/or various other suitable devices.

The laundry appliance 1002 may be in communication with the remote user interface device 1000 device through various possible communication connections and interfaces. The laundry appliance 1002 and the remote user interface device 1000 may be matched in wireless communication, e.g., connected to the same wireless network. The laundry appliance 1002 may communicate with the remote user interface device 1000 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the appliance 10 and the remote user interface device 1000. For example, BLUETOOTH® Low Energy may advantageously minimize the power consumed by the exemplary methods and devices described herein due to the low power networking protocol of BLUETOOTH® Low Energy.

The remote user interface device 1000 is “remote” at least in that it is spaced apart from and not physically connected to the laundry appliance 1002, e.g., the remote user interface device 1000 is a separate, stand-alone device from the laundry appliance 1002 which communicates with the laundry appliance 1002 wirelessly. Any suitable device separate from the laundry appliance 1002 that is configured to provide and/or receive communications, information, data, or commands from a user may serve as the remote user interface device 1000, such as a smartphone (e.g., as illustrated in FIG. 4), smart watch, personal computer, smart home system, or other similar device. For example, the remote user interface device 1000 may be a smartphone operable to store and run applications, also known as “apps,” and some or all of the method steps disclosed herein may be performed by a smartphone app.

The remote user interface device 1000 may include a memory for storing and retrieving programming instructions. Thus, the remote user interface device 1000 may provide a remote user interface which may be an additional user interface to the user interface panel 100. For example, the remote user interface device 1000 may be a smartphone operable to store and run applications, also known as “apps,” and the remote user interface may be provided as a smartphone app.

As mentioned above, the laundry appliance 1002 may also be configured to communicate wirelessly with the cloud 1100, e.g., one or more remote computing devices, such as a remote database, remote server, etc., in a distributed computing environment. Such distributed computing environments may include, for example, cloud computing, fog computing, and/or edge computing. For example, the cloud 1100 may be or include a remote database which may be, e.g., a cloud-based data storage system. For example, the laundry appliance 1002 may communicate with the cloud 1100 over the Internet, which the laundry appliance 1002 may access via WI-FI®, such as from a WI-FI® access point in a user's home.

The remote user interface device 1000 may include a memory for storing and retrieving programming instructions. Thus, the remote user interface device 1000 may provide a remote user interface which may be an additional user interface to the user interface panel 100. For example, the remote user interface device 1000 may be a smartphone operable to store and run applications, also known as “apps,” and the remote user interface may be provided as a smartphone app.

In some embodiments, the performance of exemplary methods and associated method steps as disclosed herein may be distributed, e.g., performed in part by the controller 210 and in part by one or more remote computing devices in the cloud 1100 and/or remote user interface device 1000.

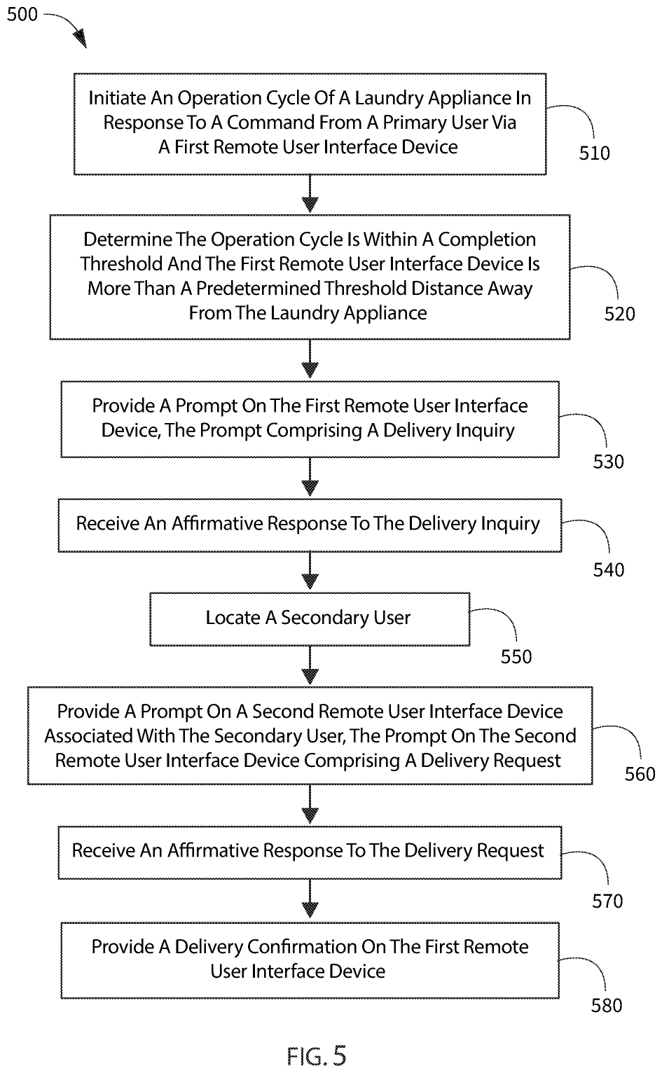

As illustrated in FIG. 5, embodiments of the present disclosure also include methods of operating a laundry appliance, e.g., one of the laundry appliances described above, such as washing machine appliance 10 or dryer appliance 11, among other possible exemplary laundry appliances, such as a washer-dryer combination appliance. Exemplary methods according to the present subject matter include the method 500 illustrated in FIG. 5. Methods such as method 500 can be used to operate any suitable laundry appliance. For example, such methods may be utilized to operate washing machine appliance 10 or dryer appliance 11 (FIGS. 1 through 3). Controller 210 of laundry appliance 10 or 11 may be programmed to implement method 500, e.g., controller 210 is capable of and may be operable to perform any methods and associated method steps as disclosed herein. In some embodiments, the controller 210 may perform method steps in combination with one or more remote computing devices, such as a remote database or remote processor or one or more other remote computing devices, e.g., in a distributed computing environment such as the cloud, the fog, and/or the edge. Thus, references herein to a “remote computing device” include at least one such device with which a laundry appliance and/or remote user interface device communicates, e.g., over the internet, such as one or more remote computing devices in the cloud, etc. In such embodiments, the controller 210 may communicate with such remote computing device or devices via the internet, among other possible communications means. For example, some embodiments of the methods disclosed herein may include distributed computing whereby certain steps or calculations/determinations are performed locally, e.g., by the controller 210 onboard the laundry appliance 10 or 11, while other steps or calculations/determinations are performed by a remote computing device with which the controller 210 communicates, e.g., via the internet.

As illustrated in FIG. 5, the method 500 may include a step 510 of initiating an operation cycle of the laundry appliance in response to a command from a primary user via a first remote user interface device. The operation cycle may be any laundry cycle, such as a wash cycle in washing machine appliance, a dry cycle in a dryer appliance, or both in a combination laundry appliance, among other possible laundry cycles. Initiating the operation cycle of the laundry appliance, e.g., in step 510 of method 500, includes causing at least one mechanical component of the laundry appliance to be operated. For example, the mechanical component may be a motor, such as the motor 122 of the washing machine appliance or the motor 31 of the dryer appliance, a fan, a heating element, a pump, a compressor, or a valve, among other possible example mechanical components of a laundry appliance. Also, operating the mechanical component includes changing a physical status of the component, e.g., a speed, position, etc. of the component, such as accelerating the motor, fan, etc., e.g., from a zero starting speed, opening a valve, and/or other changes in the physical state of one or more mechanical components of the laundry appliance. The operation cycle may be performed in response to a user input, e.g., received locally, such as with user interface panel 100, or remotely, such as via a remote user interface device, e.g., remote user interface device 1000 described above in reference to FIG. 4. For example, in some embodiments, the command from the primary user via the first remote user interface device in response to which the operation cycle is initiated may be a reservation command, whereby the laundry appliances is reserved for the primary user and only unlockable to initiate the operation cycle by the primary user, e.g., via the first remote user interface device, and the operation cycle may commence after unlocking in response to a start command received either locally or remotely as described. Thus, in various embodiments, the command from the primary user via the first remote user interface device in response to which the operation cycle is initiated may be or include at least a reservation command and/or unlock command and may also include a start command received via the first remote user interface device.

Method 500 may further include a step 520 of determining the operation cycle is within a completion threshold and determining the first remote user interface device is more than a predetermined threshold distance away from the laundry appliance.

One or more exemplary methods according to the present disclosure may be location-based. Such location-based methods may, for example, include determining the remote user interface device is more than a predetermined threshold distance away from the laundry appliance. For example, where the remote interface device is a smartphone or smartwatch or other similar device which is typically carried on the user's person, the location of the remote user interface device may be inferred as the same location of the primary user. The predetermined threshold distance may be, for example, about fifty meters, or any other suitable distance which is large enough to indicate that the user has left the laundromat, e.g., any distance which is greater than common dimensions of a laundromat building and/or curtilage thereof, including associated parking lots and other ancillary areas adjacent to the laundromat building.

In various embodiments, the completion threshold may be a percentage, such as a minimum percentage of the overall operation cycle, or a time, such as a minimum remaining time until completion of the operation cycle, or other similar completion threshold. For example, the completion threshold may be about fifteen minutes or less, and determining that the operation cycle is within the completion threshold may include determining that there is fifteen minutes or less remaining in the operation cycle.

As illustrated in FIG. 5, method 500 may further include a step 530 of providing a prompt on the first remote user interface device because the operation cycle is within the completion threshold and the first remote user interface device is more than the predetermined threshold distance away from the laundry appliance. For example, the prompt on the first remote user interface device may include a delivery inquiry, e.g., asking whether the primary user would like to hire another user, e.g., a secondary user, to deliver his or her laundry.

In some embodiments, exemplary methods according to the present disclosure may further include receiving an affirmative response to the delivery inquiry, e.g., as indicated at 540 in FIG. 5. For example, the prompt may be a pop-up or other similar prompt, e.g., as a push message or notification from a remote computing device to the first remote user interface device, and may include a delivery inquiry asking whether the primary user wants to hire another user, e.g., a secondary user, to deliver the load of articles from the laundry appliance. The affirmative response may include, for example, a selection, such as a tap, on a “Yes” option in the prompt or other similar affirmative option, e.g., a green light, thumbs up icon, etc.

Method 500 may also include a step 550 of locating a secondary user, e.g., who may be willing and able to deliver the primary user's laundry. For example, the secondary user may be a user who shares a common residential zone with the primary user. The residential zone may vary based on the context of the laundromat. For example, when the laundromat is located on a college campus, the residential zone may be a same dormitory building, a group of two or more neighboring buildings, or the same area, e.g., floor or group of floors, in a dormitory building. As another example, when the laundromat is located in an apartment building, the residential zone may include the same building or complex. Thus, the common residential zone generally encompasses an area in which the secondary user may conveniently travel, e.g., where the primary user's residence is not out of the secondary user's way when the secondary user is travelling home from the laundromat.

The secondary user may also or instead have a completion time within a same time frame as the completion time of the operation cycle which was initiated at step 510. For example, the laundry appliance may be a first laundry appliance. In such embodiments, the method may further include initiating an operation cycle of a second laundry appliance in response to a command from the second remote user interface device, e.g., the second laundry appliance may be located in a common location with the first laundry appliance. In such embodiments, locating the secondary user may include identifying the secondary user based on a completion time of the operation cycle of the second laundry appliance. For example, the secondary user may be identified based on determining that the completion time of the operation cycle of the second laundry appliance is within a time limit of a completion time of the operation cycle of the first laundry appliance.

After a secondary user, or potential secondary user, e.g., a user who may be willing to deliver the primary user's laundry, is located, the method 500 may include contacting the secondary user, e.g., as illustrated at 560 in FIG. 5, providing a prompt on a second remote user interface device associated with the secondary user after receiving the affirmative response to the delivery inquiry, where the prompt on the second remote user interface device may include a delivery request. As mentioned above in the context of the first remote user interface device, the second remote user interface device may also receive a push message or notification from a remote computing device, e.g., the prompt including the delivery request may be a pop-up or other message on the second remote user interface device asking the secondary user whether the secondary user will deliver the primary user's laundry. In addition to the delivery request, the prompt may also include other information, such as the location to which the laundry is to be delivered, such as a general location, e.g., an identification of the primary user's building or floor which may not include the primary user's specific room until the delivery request is accepted or confirmed. Such other information which may be included may also include a price or payment the secondary user is offered for the delivery, a time frame in which delivery is expected, or other similar logistical information, in various combinations. For example, in some embodiments, the secondary user may receive a delivery fee that is based on the distance to the primary user's residence, the time of day, and/or the level of traffic in the residential zone, among other factors and combinations of factors. In additional embodiments, the price may be a fixed price, such as for all deliveries within the same residential zone.

Still referring to FIG. 5, the method 500 may also include receiving an affirmative response to the delivery request, such as via the second remote user interface device, e.g., in a similar manner as described above with respect to the affirmative response to the delivery inquiry via the first remote user interface device.

In some embodiments, the method 500 may also include a step 580 of providing a delivery confirmation on the first remote user interface device. For example, providing the delivery confirmation on the first remote user interface device may include receiving, b y the remote computing device from the second remote user interface device, the delivery confirmation, e.g., a photograph of the laundry at the primary user's residence, and sending, from the remote computing device, the delivery confirmation to the primary user at the first remote user interface device.

In some embodiments, one or more methods according to the present disclosure may include locking the laundry appliance after initiating the operation cycle and unlocking the laundry appliance based on the affirmative response to the delivery request. Locking the laundry appliance may include, for example, locking the laundry appliance during the operation cycle. Locking the laundry appliance may include locking a door or lid of the laundry appliance. Locking the laundry appliance may also or instead include locking the controls of the laundry appliance, such as disabling the local interface or local input devices, e.g., input device 102 (FIG. 1), of the laundry appliance, such that commands, settings, or other input received from the local input device or devices are not implemented while the laundry appliance remains locked. The local interface or local input devices may also include, for example, the user interface panel 100 (FIG. 1) and all input components thereof, e.g., display 104 in embodiments where display 104 is a touchscreen, and any other buttons, switches, etc., on the user interface panel 100. For example, in embodiments where the laundry appliance does not include a lock on the door or lid, locking the laundry appliance may include only locking the controls. Exemplary methods according to the present disclosure may further include unlocking the laundry appliance based on the affirmative response to the delivery request, such as authorizing the secondary user to access the laundry appliance in order to collect the load of articles therefrom for delivery. For example, unlocking the laundry appliance may include enabling the local input device and/or implementing a command or other input received via the local input device. As another example, unlocking the laundry appliance may also or instead include unlocking a door or lid of the laundry appliance.

In some embodiments, exemplary methods according to the present disclosure may include verifying the secondary user. For example, the secondary user may be verified using a student identification card (student ID), e.g., when the laundromat is on a college campus, a key (such as a dormitory key or a key to an apartment building, condominium complex, etc.), or other source of residency information which may be used to confirm that the secondary user does in fact live or reside in the residence zone. Thus, in such embodiments, the secondary user may be a verified user. Such exemplary methods may further include providing a verification of the secondary user to the first remote user interface device after receiving the affirmative response to the delivery request. For example, a photo or other identifying information of the secondary user may be provided on the first remote user interface device, such as the remote computing device may transmit a cropped image of a student ID or driver's license belonging to the secondary user, e.g., cropped so that only the facial image of the secondary user is visible without revealing further personal information of the secondary user on the first remote user interface device.

The primary user may be charged for the delivery service, and the secondary user may be paid for the delivery service. Such charges and payments may be handled, for example, in an application or “app,” e.g., on each of the first remote user interface device and the second remote user interface device, such as first and second smartphones, and the transaction may be mediated in a remote computing device and/or distributed computing environment. For example, money may be withdrawn from the primary user's account via the app and money may be credited to the secondary user's account via the app, where each such account may be maintained in the remote computing device, e.g., cloud. In some embodiments, a processing fee or surcharge may be added to the delivery service fee, e.g., the amount withdrawn from the primary user's account may be not the same as the amount credited to the secondary user's account, e.g., the amount withdrawn may be higher due to the inclusion of the processing fee. In some embodiments, the credit may not be transferred unless or until the primary user is satisfied and/or confirms that the delivery was completed. For example, one or more exemplary methods according to embodiments of the present disclosure may include receiving a payment authorization from the first remote user interface device after providing the delivery confirmation. Such embodiments may also include applying a credit to an account associated with the secondary user, e.g., in the cloud, in response to the payment authorization.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a laundry appliance, the method comprising:
initiating an operation cycle of the laundry appliance in response to a command from a primary user via a first remote user interface device;
determining the operation cycle is within a completion threshold and the first remote user interface device is more than a predetermined threshold distance away from the laundry appliance;
providing a prompt on the first remote user interface device because the operation cycle is within the completion threshold and the first remote user interface device is more than the predetermined threshold distance away from the laundry appliance, the prompt on the first remote user interface device comprising a delivery inquiry;
receiving an affirmative response to the delivery inquiry;
locating a secondary user;
providing a prompt on a second remote user interface device associated with the secondary user after receiving the affirmative response to the delivery inquiry, the prompt on the second remote user interface device comprising a delivery request;
receiving an affirmative response to the delivery request; and
providing a delivery confirmation on the first remote user interface device.

2. The method of claim 1, further comprising locking the laundry appliance after initiating the operation cycle and unlocking the laundry appliance based on the affirmative response to the delivery request.

3. The method of claim 1, wherein locating the secondary user comprises identifying the secondary user based on a common residential zone with the primary user.

4. The method of claim 1, wherein the laundry appliance is a first laundry appliance, further comprising initiating an operation cycle of a second laundry appliance in response to a command from the second remote user interface device, the second laundry appliance located in a common location with the first laundry appliance, and wherein locating the secondary user comprises identifying the secondary user based on a completion time of the operation cycle of the second laundry appliance.

5. The method of claim 4, wherein the secondary user is identified based on determining the completion time of the operation cycle of the second laundry appliance is within a time limit of a completion time of the operation cycle of the first laundry appliance.

6. The method of claim 1, further comprising receiving a payment authorization from the first remote user interface device after providing the delivery confirmation.

7. The method of claim 6, further comprising applying a credit to an account associated with the secondary user in response to the payment authorization.

8. The method of claim 1, wherein the laundry appliance is a dryer appliance.

9. The method of claim 1, wherein the secondary user is a verified user, further comprising providing a verification of the secondary user to the first remote user interface device after receiving the affirmative response to the delivery request.

10. A method of operating a laundry appliance, the method comprising:
initiating an operation cycle of the laundry appliance in response to a command from a primary user via a first remote user interface device;
providing a prompt on the first remote user interface device, the prompt on the first remote user interface device comprising a delivery inquiry;
receiving an affirmative response to the delivery inquiry;
locating a secondary user;
providing a prompt on a second remote user interface device associated with the secondary user after receiving the affirmative response to the delivery inquiry, the prompt on the second remote user interface device comprising a delivery request;
receiving an affirmative response to the delivery request; and
providing a delivery confirmation on the first remote user interface device.

11. The method of claim 10, further comprising determining the operation cycle is within a completion threshold, wherein the prompt on the first remote user interface device comprising the delivery inquiry is provided in response to determining the operation cycle is within the completion threshold.

12. The method of claim 10, further comprising determining the first remote user interface device is more than a predetermined threshold distance away from the laundry appliance, wherein the prompt on the first remote user interface device comprising the delivery inquiry is provided in response to determining the first remote user interface device is more than the predetermined threshold distance away from the laundry appliance.

13. The method of claim 10, further comprising locking the laundry appliance after initiating the operation cycle and unlocking the laundry appliance based on the affirmative response to the delivery request.

14. The method of claim 10, wherein locating the secondary user comprises identifying the secondary user based on a common residential zone with the primary user.

15. The method of claim 10, wherein the laundry appliance is a first laundry appliance, further comprising initiating an operation cycle of a second laundry appliance in response to a command from the second remote user interface device, the second laundry appliance located in a common location with the first laundry appliance, and wherein locating the secondary user comprises identifying the secondary user based on a completion time of the operation cycle of the second laundry appliance.

16. The method of claim 15, wherein the secondary user is identified based on determining the completion time of the operation cycle of the second laundry appliance is within a time limit of a completion time of the operation cycle of the first laundry appliance.

17. The method of claim 10, further comprising receiving a payment authorization from the first remote user interface device after providing the delivery confirmation.

18. The method of claim 17, further comprising applying a credit to an account associated with the secondary user in response to the payment authorization.

19. The method of claim 10, wherein the laundry appliance is a dryer appliance.

20. The method of claim 10, wherein the secondary user is a verified user, further comprising providing a verification of the secondary user to the first remote user interface device after receiving the affirmative response to the delivery request.
